(19) United States
(12) Patent Application Publication
(10) Pub. No.: US 2023/0257007 A1
(43) Pub. Date: Aug. 17, 2023

(54) CONTACTLESS INTELLIGENT CUSTOMER-SERVICE SYSTEM APPLIED TO RAIL TRANSIT AND APPLICATION METHOD THEREOF

(71) Applicant: CASCO SIGNAL LTD., Shanghai (CN)

(72) Inventors: Shuanglei YANG, Shanghai (CN); Enhua HU, Shanghai (CN); Bingjian ZHANG, Shanghai (CN); Jiafu PEI, Shanghai (CN); Li LIN, Shanghai (CN); Xiangping ZHU, Shanghai (CN); Ning ZHENG, Shanghai (CN); Dewei LIU, Shanghai (CN)

(73) Assignee: CASCO SIGNAL LTD., Shanghai (CN)

(21) Appl. No.: 18/013,263

(22) PCT Filed: Sep. 23, 2021
(86) PCT No.: PCT/CN2021/119757

§ 371 Date: Dec. 28, 2022

(30) Foreign Application Priority Data
Dec. 18, 2020 (CN) 202011500384.5

(51) Int. Cl. B61L 15/00; G10L 15/22; G06V 40/16

(52) U.S. Cl. CPC B61L 15/0018; B61L 15/0045; G10L 15/22; G06V 40/16; G10L 2015/223

(57) ABSTRACT

The present invention relates to a contactless intelligent customer-service system applied to rail transit and an application method thereof. The system includes: an intelligent customer-service platform server, an intelligent customer-service interface server, a system switch, a station maintenance workstation, and an intelligent passenger service terminal, where the system switch is connected to each of the intelligent customer-service platform server, the intelligent customer-service interface server, the station maintenance workstation, and the intelligent passenger service terminal; and the intelligent passenger service terminal provides, through AI interaction and intelligent speech, a passenger with intelligent services that include information inquiry and display of various facilities inside a station, information inquiry of convenient surrounding facilities, information inquiry of a train operation status, and emergency help. Compared with the prior art, the present invention has the advantages of intelligence, diversification, personalization, high efficiency, comprehensive service information, comprehensive service functions and the like.

### FIELD OF TECHNOLOGY

The present invention relates to the field of urban rail transit, and in particular to a contactless intelligent customer-service system applied to rail transit and an application method thereof.

### BACKGROUND

In recent years, with the continuous development and advancement of big data, artificial intelligence technology and smart cities, passengers have put forward higher demands on travel convenience, personalization, and self-service. In addition, in the current situation of the coexistence between the coronavirus and human life, the epidemic has had a great impact on people's travel and life. Especially, it is necessary to avoid contact in the use of rail transit, which serves the public, so as to reduce the spread of the virus. Therefore, it is imminent to achieve intelligentization and informatization of passenger service terminals at rail transit stations, and to prevent epidemic at the same time.

The existing passenger service generally is provided manually using the ticket booth and the passenger service center, or the vehicle control room is also used as the service center. In addition, the existing service terminal functions are relatively simple, and more manual participation is required to complete it, which is not conducive to improving the operational service level and operational efficiency.

### SUMMARY

An objective of the present invention is to overcome the defects in the prior art, and provide a contactless intelligent customer-service system applied to rail transit and an application method thereof.

The objective of the present invention can be implemented by using the following technical solutions:

According to an aspect of the present invention, a contactless intelligent customer-service system applied to rail transit is provided, including: an intelligent customer-service platform server, an intelligent customer-service interface server, a system switch, a station maintenance workstation, and an intelligent passenger service terminal, where the system switch is connected to each of the intelligent customer-service platform server, the intelligent customer-service interface server, the station maintenance workstation, and the intelligent passenger service terminal; and

the intelligent passenger service terminal provides, through AI interaction and intelligent speech, a passenger with intelligent services that include information inquiry and display of various facilities inside a station, information inquiry of convenient surrounding facilities, information inquiry of a train operation status, and emergency help.

In a preferred technical solution, the intelligent customer-service interface server accesses professional system interface information through network isolation equipment, where the interface information includes external system interface information and internal relevant system interface information of the rail transit, the external system interface information includes a weather forecast, a subway line map, and bus and subway transfer information, and the internal relevant system interface information of the rail transit includes ATS driving information, clock system information, first- and last-train information, emergency news release information, and congestion degree information; and

the intelligent customer-service interface server has an interface protocol conversion function, and supports standard protocols and private protocols of a plurality of professional system interfaces.

In a preferred technical solution, the network isolation device has a network isolation function and a unidirectional data flow communication function.

In a preferred technical solution, the intelligent customer-service platform server includes a background application service processing module and a database management module;

the intelligent customer-service interface server accesses professional system interface information, the interface information is processed by a linkage engine built in the intelligent customer-service platform server, and a linkage result is converted into data through the system switch and pushed to the intelligent passenger service terminal in the form of text, picture, and video; and

a performance parameter of the intelligent customer-service platform server is determined by a quantity of the intelligent passenger service terminals.

In a preferred technical solution, the station maintenance workstation, serving as a client of a system service program, is connected to each of the intelligent customer-service platform server, the intelligent customer-service interface server, and the intelligent passenger service terminal through the system switch, so as to deploy and maintain software of an intelligent passenger service system.

In a preferred technical solution, the intelligent passenger service terminal includes an LCD display or an OLED transparent display for display, a power controller for power control, a broadcast control host for playback control, a camera configured to sense appearance characteristics of a passenger, microphone equipment for an interaction with a passenger service center and speech self-service inquiry during a manual service, a somatosensory sensor configured to support a contactless operation interaction between the passenger and a service terminal, and a touch screen for supplementary means of a conventional operation.

In a preferred technical solution, the microphone equipment is used for the interaction with the passenger service center and the speech self-service inquiry when a manual service is required, the speech recognition is performed by using a speech synthesis module and a speech dictation module that are configured to perform mutual conversion and interaction between text information and sound information.

In a preferred technical solution, when the intelligent passenger service terminal is not used, the terminal stays on a wake-up interface on which a publicity poster or an advertisement of a rail transit station is posted, and the main interface is designed for eye-catching wake-up guidance; and when a passenger uses the terminal, the passenger is guided to wake up the terminal through a keyword set on the wake-up interface, the device switches to an operating state of the main interface, and all interfaces support a speech interaction function and respond to an instruction of an operator in time.

In a preferred technical solution, the camera is a face recognition camera, the face recognition camera is configured to perceive appearance characteristics of a passenger, determine the age, gender, and country of the passenger through the face recognition, and customize and push, according to a recognition result, a human-machine interface, a human-machine interaction language, and interactive information that meet the passenger's characteristics, and the system continuously performs machine learning based on the recognition record, trains a relationship model and knowledge management database, and pushes more personalized information.

In a preferred technical solution, the somatosensory sensor uses a gesture interaction method to perform a somatosensory interaction function, all instructions and operations of the passenger can be completed by using gestures, and the passenger performs the self-service inquiry service in a conventional operation manner of touching a screen.

In a preferred technical solution, the intelligent passenger service terminal includes an intelligent information-service inquiry module, so as to establish a data model and analyze and select big data according to frequently asked questions about passenger travel at subway stations of the rail transit, such that in combination with a more friendly human-machine interface and interactive design, a faster and more customized inquiry experience is provided for a passenger; and

the intelligent information-service inquiry module is integrated with AI interaction, and responds to and answers in real time questions raised by users, 10 popular questions pushed for self-service inquiry and a manual service call button are set on an inquiry interface, when in need of a manual service, a passenger taps an online connection button to enter a video connection interface, and enters a connection interface after connecting, and the interface includes a personal video, a volume status, connection duration information, and a disconnection button.

In a preferred technical solution, the intelligent passenger service terminal includes an intelligent navigation guidance module for in-station navigation, station surrounding navigation, and transfer guidance, and the intelligent navigation guidance module is combined with third-party commercial navigation software to perform navigation inside and outside a rail transit subway station based on Bluetooth positioning and navigation technology; and

a map module in the intelligent navigation guidance module displays all route maps of a subway and ground buses in a whole city, and when a passenger enters information of a starting station and of a terminal station to query a route, a route plan and details thereof are highlighted on the route map, so that the passenger can quickly find a travel and transfer route as well as transfer information.

In a preferred technical solution, the intelligent passenger service terminal is equipped with an intelligent riding guidance module, the intelligent riding guidance module accesses ATS, first- and last-train information, and congestion degree information, such that in addition to a series of information of train operation in real time, a passenger is further provided with information about closure of entrances and exits, a station operation adjustment with a large passenger flow, and an emergency such as a fire, a large-scale train delay, a terrorist attack, and a natural disaster, so as to guide the passenger to travel or avoid an impact of the operational adjustment.

In a preferred technical solution, the intelligent passenger service terminal is equipped with a manual call service module, when the system cannot meet needs of a passenger or the passenger has urgent needs for help, a real-time video call for inquiry is made to station staff who are responsible for processing inquiries, and the system should be equipped with mobile video intercom equipment for station staff.

In a preferred technical solution, the intelligent passenger service terminal further includes the following functional modules:

an advertising interface module configured to display texts, pictures, and videos in rotation, where speech wake-up guidance is set up in a central region of the interface, and in this way, a passenger is guided to wake up the system by using a speech involving a keyword, and then the system exits the advertising interface module, that is, enters a face recognition interface; and the system automatically switches back to the advertising interface module without sensing an operation of the passenger within 30 s;

a home page module configured for system time display, station 3D model display, general emergency message display, and including a home button, an information service button, a map button, a train information button, and an inquiry button, where when the passenger taps the button on the interface, the system module automatically switches to a corresponding module interface;

an information service module configured to display an interface of an information service list and corresponding list content, where the information service list is on the left side of the display interface, and when the passenger taps a data bar in the list, corresponding information data content is displayed on the right side;

a train information module configured to display first- and last-train time information of a transfer line, running information of upward and downward trains, information of first two trains of different lines, a name of a next station, terminal station information, arrival time information, and comfort information, according to different platforms, where the text information is displayed in a standard color corresponding to a line name, and information of different lines is displayed in rotation; and

a full-screen emergency message module, configured to enable intelligent passenger service terminal equipment to automatically switch to a full-screen emergency message mode when an emergency occurs at a station.

According to another aspect of the present invention, an application method for the contactless intelligent customer-service system applied to rail transit is provided, including the following steps:

step 1: unidirectionally accessing each interface system information by using network isolation equipment, aggregating these information, and sending the aggregated information to an intelligent customer-service interface server, where each of interface systems includes: a weather forecast interface, a subway line map interface, a bus and subway transfer information interface, an ATS system interface, a clock system interface, a first- and last-train system interface, an emergency message system interface, and a congestion degree system interface;

step 2: obtaining, by the intelligent customer-service interface server, information closely related to a passenger service, and forwarding the information to a passenger service platform server, where information closely related to passenger scheduling includes a weather forecast, a subway line map, bus and subway transfer information, ATS system driving information, clock system information, first- and last-train information, emergency message system interface information, and congestion degree information;

step 3: according to a predefined operational business definition and logic, associating, by the intelligent passenger service interface server, comprehensive information of these interfaces, training a model, and performing statistical analysis and decision-making;

step 4: performing, by a linkage engine of the intelligent passenger platform server, inter-system linkage, based on input conditions;

step 5: pushing, by the intelligent passenger platform server, a linkage result and an analysis decision result to the intelligent passenger service terminal; and

step 6: displaying, by the intelligent passenger service terminal, the pushed information, and responding to an interaction instruction of a passenger.

In a preferred technical solution, the weather forecast interface provides the system with information such as a current day weather, a dynamic weather forecast in next 1 to 3 hours, and a weather in next 7 days;

the subway line map interface provides the system with a latest urban rail transit subway line map;

the bus and subway transfer information interface provides the system with transfer information between an urban subway and a ground public transportation system, and the transfer information includes travel time, congestion degrees, walking distances, travel costs, and transfer times of a travel path;

the ATS system interface provides the system with information on whether an operating train is in a normal operating mode, a main operating condition of a signal system, and an operating timetable;

the clock system interface provides the system with reference master clock time information and a reference time;

the first- and last-train system interface provides the system with a timetable of first and last trains of each station of a rail transit subway;

the emergency message system interface provides the system with release of various emergency messages, including fire information, large-scale train delay information, terrorist attack information, and natural disaster information, where the fire information is provided by a FAS subsystem interface of a smart station, the large-scale train delay information is provided by an ATS subsystem interface of the smart station, and the terrorist attack information and natural disaster information are provided by a PIS information release system of the smart station; and

the congestion degree system interface provides the system with the congestion degree and comfort information of last three train cars that are about to arrive at the station.

In a preferred technical solution, the inter-system linkage performed by the linkage engine based on the input condition is specifically as follows:

the linkage engine, based on the workflow mechanism, organically links systems supporting businesses of the weather forecast, the subway line map, bus and subway transfer, and ATS driving with a clock system, a first- and last-train system, an emergency message system, and a congestion degree system together, and according to a predefined passenger service mechanism, a serial or parallel response to a passenger's interactive command on the service terminal is performed.

Compared with the prior art, the present invention has the following advantages.

1) The intelligent passenger service terminal of the present invention is linked with interface information of a plurality of professional systems of the station by integrating technologies such as artificial intelligence AI interaction, artificial intelligence video recognition, and visual audio and video, and provides passengers with more convenient and quick inquiry service, self-service, and other multi-professional information services through a more friendly and efficient contactless interface operation process design. Therefore, the present invention has the advantages of intelligence, diversification, personalization, high efficiency, comprehensive service information, comprehensive service functions, and the like, thereby improving the travel experience of passengers and the satisfaction with rail transit intelligent operation services.

2) In the present invention, the station interface server device organically accesses the information closely related to passenger travel and service in the ATS driving system to construct an integrated intelligent passenger service system.

3) In the present invention, on the basis of the intelligent video and speech recognition technology, the video recognition analysis device and the speech interaction device mounted on the intelligent passenger service terminal can intelligently perceive and acquire the characteristics of passengers (users) and provide personalized services.

4) The present invention can save the human resources of the station customer-service center and the vehicle control room, has high service efficiency, and realizes unmanned or less manned duty.

5) In the present invention, the intelligent passenger service engine and linkage engine efficiently organize various business systems to work together and assist in the intelligentization of the passenger service systems, which can further improve the travel experience of passengers and improve passengers' satisfaction with intelligent operation services of the rail transit.

### BRIEF DESCRIPTION OF THE DRAWINGS

FIG. 1 is a schematic diagram of a system structure according to the present invention;

FIG. 2 is a flowchart of an intelligent passenger service system according to the present invention; and

FIG. 3 is a flowchart of intelligent passenger service man-machine interaction according to the present invention, where

1 represents a station machine room, 2 represents a station control room, 3 represents an intelligent customer-service platform server, 4 represents an intelligent customer-service interface server, 5 represents network isolation equipment, 6 represents a system switch, 7 represents a station maintenance workstation, 8 represents an intelligent passenger service terminal, 9 represents an interface, and 10 represents a passenger service center.

### DESCRIPTION OF THE EMBODIMENTS

The technical solutions of the embodiments of the present invention are clearly described below with reference to the accompanying drawings in the present invention. Apparently, the described embodiments are some rather than all of the embodiments of the present invention. All other embodiments obtained by a person of ordinary skill in the art on the basis of the embodiments of the present invention without creative efforts shall fall within the protection scope of the present invention.

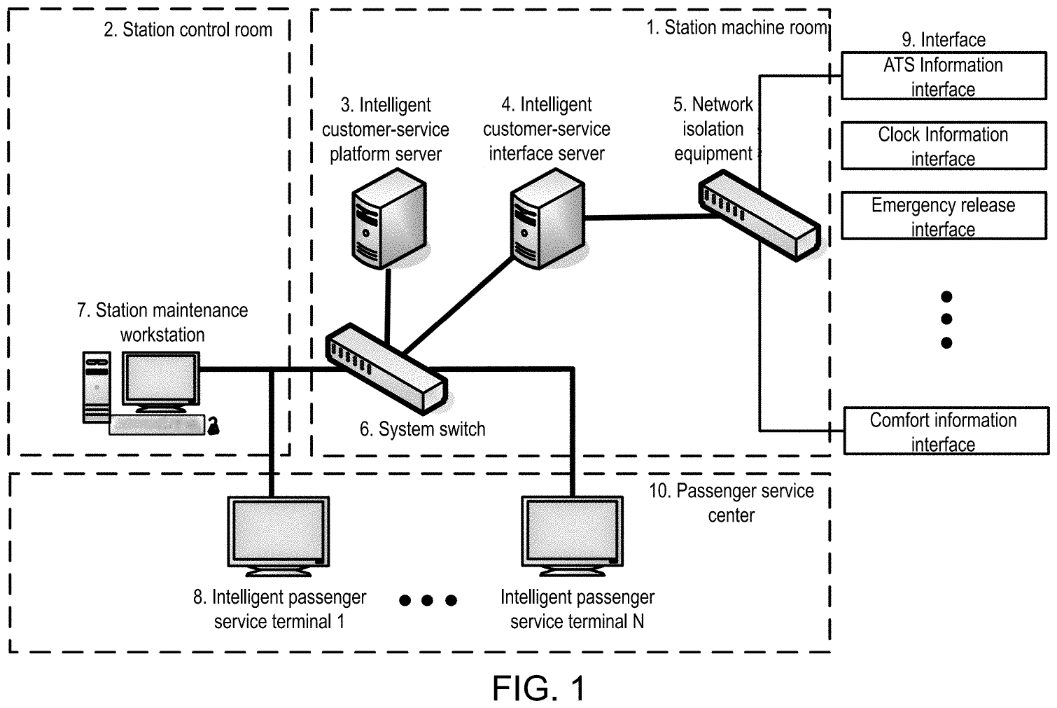

As shown in FIG. 1, the present invention is applied to a contactless intelligent customer-service system of rail transit. The system includes a station machine room 1, a station control room 2, a system switch 6, and an intelligent passenger service terminal 8. The station machine room 1 is provided with an intelligent customer-service platform server 3 and an intelligent customer-service interface server 4. The intelligent customer-service platform server 3, the intelligent customer-service interface server 4, and the passenger intelligent service terminal 8 are connected by a system switch 6 in a star shape.

As shown in FIG. 1, the intelligent customer-service interface server 4 has an interface protocol conversion function, and supports standard protocols and private protocols of a plurality of professional system interfaces. Each system interface information is accessed by using the system switch 6. The each system information of the interface 9 includes:

external system interface information: a weather forecast, a subway line map, a bus and subway transfer information, and the like.

The internal relevant system interfaces of rail transit include: an ATS system interface, a clock system interface, a first- and last-train system interface, an emergency message system interface, a congestion system interface, and the like.

A linkage engine built in the intelligent customer-service platform server 3 performs digital conversion on a linkage result through the system switch 6 and pushes the converted result to the intelligent passenger service terminal 8 in the form of text, picture, and video. The performance parameters of the intelligent customer-service platform server 3 are determined by a quantity of intelligent passenger service terminals 8.

The station maintenance workstation 7, referred to as a workstation for maintaining the intelligent passenger service system, is connected to the intelligent customer-service platform server 3, the intelligent customer-service interface server 4, the intelligent passenger service terminal 8 through the system switch 6, thereby deploying and maintaining software of the intelligent customer-service platform server 3, the intelligent passenger service terminal 8, and the system switch 6.

The intelligent passenger service terminal 8 mainly includes three parts: an LCD display, a power controller, and a broadcast control host. In addition, considering the impact of the current epidemic on people's travel and life, and especially the particularity of the population-intensive tool such as rail transit, with the operation and deployment of the subway operating company for epidemic prevention and control, the terminal is integrated with cameras, microphone equipment, somatosensory sensor, and touch screens. The camera is configured to perceive the appearance characteristics of passengers; and the microphone equipment is configured for interaction with the passenger service center and speech self-service inquiry when a manual service is required. When using the somatosensory sensors to support the contactless interaction between passengers and service terminals, through gesture operations on the terminal and supplementary speech recognition interaction, the passengers can enjoy a new experience of human-machine somatosensory interaction, while avoiding unnecessary contact with public equipment. The touch screen is only used as a supplement to normal operation.

The passenger service terminal is integrated with microphone equipment, which is used for interaction with the passenger service center and voice self-service inquiry when manual service is required. Speech recognition is performed by mainly using a speech synthesis module and a speech dictation module, which realize the mutual conversion and interaction between text information and sound information. When the terminal is not used, the terminal stays on a wake-up interface on which a publicity poster or an advertisement of a rail transit station may be posted, and the main interface is designed for eye-catching wake-up guidance; and when a passenger uses the terminal, the passenger is guided to wake up the terminal through a keyword set on the wake-up interface, the device switches to an operating state of the main interface, and all interfaces support a speech interaction function and respond to an instruction of an operator in time.

The passenger service terminal is integrated with a face recognition camera. The camera is configured to perceive appearance characteristics of a passenger, determine the age, gender, and country of the passenger through the face recognition, and customize and push, according to a recognition result, a human-machine interface, a human-machine interaction language, and interactive information that meet the passenger's characteristics, and the system continuously performs machine learning based on the recognition record, trains a relationship model and knowledge management database, and pushes more personalized information.

The passenger service terminal is integrated with a touch screen and a somatosensory sensor, so that the terminal has a somatosensory interaction function. Based on the wide application of 3D sensors, gesture interaction has been widely popularized. Therefore, the system uses gesture interaction to perform the somatosensory interaction function. All instructions and operations of passengers can be completed through gestures, thereby avoiding unnecessary contact with terminal equipment and reducing the way the virus spreads. The touch screen can be used as a regular operation method after the epidemic prevention and control are completed, and passengers can tap the screen to conduct self-service inquiry services.

The passenger service terminal has an intelligent information-service inquiry function, this system is configured to establish a data model and analyze and select big data according to frequently asked questions about passenger travel at subway stations of the rail transit, and this system, with a more friendly human-machine interface and interactive design, provides passengers with a faster and more customized inquiry experience, reducing passenger retention time, and allowing passengers to obtain the most needed information efficiently and quickly.

The passenger service terminal is provided with an intelligent navigation guidance function, and the intelligent navigation guidance function includes in-station navigation, station surrounding navigation, and transfer guidance. Based on the Bluetooth positioning and navigation technology, with the third-party commercial navigation software, the system of the present invention performs navigation inside and outside the rail transit subway station, making up for the blank that the current commercial navigation cannot cover the subway station.

The intelligent passenger service system has an intelligent riding guidance function. The intelligent passenger service system accesses ATS driving information, first- and last-train information, congestion degree information, and the like. In addition to a series of information of train operation in real time, the passenger is further provided with information about closure of entrances and exits, a station operation adjustment due to a large passenger flow and the like, and an emergency such as a fire, a large-scale train delay, a terrorist attack, and a natural disaster, so as to guide the passenger to travel or avoid an impact of the operational adjustment.

The passenger service terminal has a manual call service function. When the system cannot meet needs of a passenger or the passenger has urgent needs for help, a real-time video call for inquiry can be made to station staff who are responsible for processing inquiries, and the system should be equipped with mobile video intercom equipment for station staff.

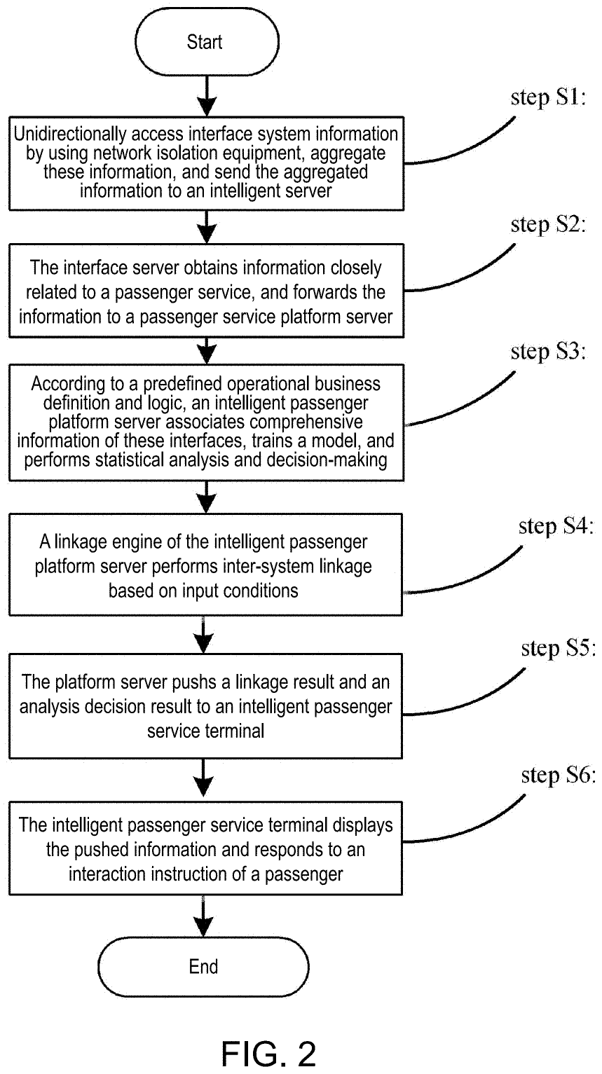

As shown in FIG. 2, an application method for an intelligent passenger service system based on a smart station includes the following steps:

step 1: Unidirectionally access each interface system information by using network isolation equipment, aggregate these information, and send the aggregated information to an interface server, where each of interface systems includes: a weather forecast, a subway line map, bus and subway transfer information, an ATS system, a clock system, a first- and last-train system interface, an emergency message system interface, and a congestion degree system interface.

The weather forecast interface can provide the system with information such as a current day weather, a dynamic weather forecast in next 1 to 3 hours, and a weather in next 7 days; the subway line map interface can provide the system with a latest urban rail transit subway line map; the bus and subway transfer information interface can provide the system with transfer information between an urban subway and a ground public transportation system, and the transfer information includes travel time, congestion degrees, walking distances, travel costs, and transfer times of a travel path; the ATS system interface can provide the system with information on whether an operating train is in a normal operating mode, a main operating condition of a signal system, and an operating timetable; the clock system interface can provide the system with reference master clock time information; the first- and last-train system interface can provide the system with a timetable of a first and last trains of each station of a rail transit subway, avoiding the impact on the daily travel of passengers; the emergency message system interface can provide the system with release of various emergency messages, such as a fire, a large-scale train delay, a terrorist attack, and a natural disaster, where the fire information may be provided by a FAS subsystem interface of a smart station, the large-scale train delay information may be provided by an ATS subsystem interface of the smart station, and the terrorist attack information and natural disaster information may be provided by a PIS information release system of the smart station; and the congestion degree system interface can provide the system with the congestion degree and comfort information of last three train cars that are about to arrive at the station, so that passengers can freely choose a carriage with a relatively small number of passengers, thereby improving passengers' comfort and satisfaction with subway rides.

step 2: The interface server obtains information closely related to a passenger service, and forwards the information to a passenger service platform server, where information closely related to passenger scheduling includes a weather forecast, a subway line map, bus and subway transfer information, an ATS system, a clock system, a first- and last-train system interface, an emergency message system interface, a congestion system interface, and the like.

Step 3: A perception module is embedded and integrated in the intelligent passenger service terminal, including an intelligent face recognition camera, a speech recognition module, a touch screen and a somatosensory module. The camera is configured to perceive the appearance characteristics of passengers; the microphone speech module is used for speech self-service inquiry and interaction with the passenger service center when a passenger needs a manual service; the touch screen supports the passenger to tap the screen for self-service inquiry services, and is taken only as a backup method for somatosensory interaction; and the somatosensory sensor is configured to support touchless interactions with the passenger.

Step 4: A business analysis engine of the intelligent customer-service platform server, according to a predefined business rule or logic, performs correlation analysis and decision-making on the comprehensive information of each system interface described in step 2, big data analysis and management of inquiry records, and model training, and provides data input support for a linkage engine.

Step 5: The linkage engine automatically responds to the passenger's interactive instructions on the service terminal, and based on a workflow mechanism, organically links systems supporting businesses of the weather forecast, the subway line map, and bus and subway transfer information with the ATS system, a clock system, a first- and last-train system, an emergency message system, and a congestion degree system together, and according to a predefined passenger service mechanism, a serial or parallel response to a passenger's interactive command on the service terminal is performed.

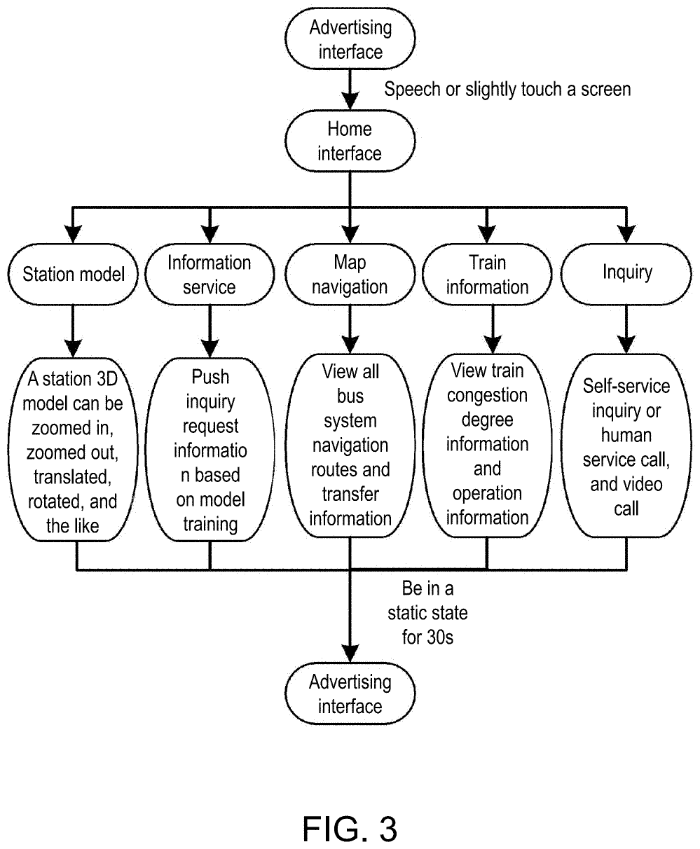

Step 6: As shown in a human-machine interaction flowchart of FIG. 3, the human-machine interaction interface design of the intelligent passenger service terminal is friendly and intuitive, and the human-machine interaction interface specifically includes:

(1) Advertising Interface Module

In an advertising interface, it is designed to display texts, pictures, and videos in rotation, where speech wake-up guidance is set up in a central region of the interface. In this way, a passenger is guided to wake up the system by using a speech involving a keyword, and then the system exits the advertising interface module, that is, enters a face recognition interface. The system automatically switches back to the advertising interface module without sensing an operation of the passenger within 30 s.

(2) Home Page Module

The home page function design mainly includes system time display, station 3D model display, general emergency message display, and a home page button, an information service button, a map button, a train information button, and an inquiry button. When the passenger taps the button on the interface, the system interface automatically switches to a corresponding interface.

(3) Information Service Module

The information service module is mainly configured to display an interface of an information service list and corresponding list content. The information service list is on the left side of the display interface, and when the passenger taps a data bar in the list, corresponding information data content is displayed on the right side. The passenger can do what they need according to the displayed information, reducing the process of passengers consulting with the staff of the station service center.

(4) Map Navigation Module

The map module displays all route maps of a subway and ground buses in a whole city, and when a passenger enters information of a starting station and of a terminal station to query a route, a route plan and details thereof are highlighted on the route map, so that the passenger can quickly find a travel and transfer route as well as transfer information.

(5) Train Information Module

A train information function is designed to display first- and last-train time information of a transfer line, running information of upward and downward trains, information of first two trains of different lines, a name of a next station, terminal station information, arrival time information, and comfort information according to different platforms. The text information is displayed in a standard color corresponding to a line name, and information of different lines is displayed in rotation.

(6) Inquiry Module

The inquiry module is integrated with AI interaction. The system responds to and answers in real time questions raised by users. Approximately 10 popular questions pushed for self-service inquiry and a manual service call button are set on an inquiry interface. When in need of a manual service, a passenger can tap an online connection button to enter a video connection interface, and enter a connection interface after connecting. The interface includes a personal video, a volume status, connection duration information, and a disconnection button.

(7) Full-Screen Emergency Message Module

When an emergency occurs at the station, the intelligent passenger service terminal equipment automatically switches to the full-screen emergency message mode. Such design is used to display the emergency message content in time to remind passengers that an emergency situation occurs, so as to quickly and effectively evacuate the station site. After that, the interface returns to the advertising interface.

The above descriptions are only specific implementations of the present invention, but the protection scope of the present invention is not limited thereto. Any person skilled in the art can easily think of various equivalents within the technical scope disclosed by the present invention. Modifications or substitutions should be included within the protection scope of the present invention. Therefore, the protection scope of the present invention should be subject to the protection scope of the claims.

To the claims:

1. A contactless intelligent customer-service system applied to rail transit, comprising: an intelligent customer-service platform server, an intelligent customer-service interface server, a system switch, a station maintenance workstation, and an intelligent passenger service terminal, wherein the system switch is connected to each of the intelligent customer-service platform server, the intelligent customer-service interface server, the station maintenance workstation, and the intelligent passenger service terminal; and
the intelligent passenger service terminal provides, through AI interaction and intelligent speech, a passenger with intelligent services that comprise information inquiry and display of various facilities inside a station, information inquiry of convenient surrounding facilities, information inquiry of a train operation status, and emergency help.

2. The contactless intelligent customer-service system applied to rail transit according to claim 1, wherein the intelligent customer-service interface server accesses professional system interface information through network isolation equipment, wherein the interface information comprises external system interface information and internal relevant system interface information of the rail transit, the external system interface information comprises a weather forecast, a subway line map, and bus and subway transfer information, and the internal relevant system interface information of the rail transit comprises ATS driving information, clock system information, first- and last-train information, emergency news release information, and congestion degree information; and
the intelligent customer-service interface server has an interface protocol conversion function, and supports standard protocols and private protocols of a plurality of professional system interfaces.

3. The contactless intelligent customer-service system applied to rail transit according to claim 2, wherein the network isolation device has a network isolation function and a unidirectional data flow communication function.

4. The contactless intelligent customer-service system applied to rail transit according to claim 1, wherein the intelligent customer-service platform server comprises a background application service processing module and a database management module;
the intelligent customer-service interface server accesses professional system interface information, the interface information is processed by a linkage engine built in the intelligent customer-service platform server, and a linkage result is converted into data through the system switch and pushed to the intelligent passenger service terminal in the form of text, picture, and video; and
a performance parameter of the intelligent customer-service platform server is determined by a quantity of the intelligent passenger service terminals.

5. The contactless intelligent customer-service system applied to rail transit according to claim 1, wherein the station maintenance workstation, serving as a client of a system service program, is connected to each of the intelligent customer-service platform server, the intelligent customer-service interface server, and the intelligent passenger service terminal through the system switch, so as to deploy and maintain software of an intelligent passenger service system.

6. The contactless intelligent customer-service system applied to rail transit according to claim 1, wherein the intelligent passenger service terminal comprises an LCD display or an OLED transparent display for display, a power controller for power control, a broadcast control host for playback control, a camera configured to sense appearance characteristics of a passenger, microphone equipment for an interaction with a passenger service center and speech self-service inquiry during a manual service, a somatosensory sensor configured to support a contactless operation interaction between the passenger and a service terminal, and a touch screen for supplementary means of a conventional operation.

7. The contactless intelligent customer-service system applied to rail transit according to claim 6, wherein the microphone equipment is used for the interaction with the passenger service center and the speech self-service inquiry when a manual service is required, the speech recognition is performed by using a speech synthesis module and a speech dictation module that are configured to perform mutual conversion and interaction between text information and sound information.

8. The contactless intelligent customer-service system applied to rail transit according to claim 7, wherein when the intelligent passenger service terminal is not used, the terminal stays on a wake-up interface on which a publicity poster or an advertisement of a rail transit station is posted, and the main interface is designed for eye-catching wake-up guidance; and when a passenger uses the terminal, the passenger is guided to wake up the terminal through a keyword set on the wake-up interface, the device switches to an operating state of the main interface, and all interfaces support a speech interaction function and respond to an instruction of an operator in time.

9. The contactless intelligent customer-service system applied to rail transit according to claim 6, wherein the camera is a face recognition camera, the face recognition camera is configured to perceive appearance characteristics of a passenger, determine the age, gender, and country of the passenger through the face recognition, and customize and push, according to a recognition result, a human-machine interface, a human-machine interaction language, and interactive information that meet the passenger's characteristics, and the system continuously performs machine learning based on the recognition record, trains a relationship model and knowledge management database, and pushes more personalized information.

10. The contactless intelligent customer-service system applied to rail transit according to claim 6, wherein the somatosensory sensor uses a gesture interaction method to perform a somatosensory interaction function, all instructions and operations of the passenger can be completed by using gestures, and the passenger performs the self-service inquiry service in a conventional operation manner of touching a screen.

11. The contactless intelligent customer-service system applied to rail transit according to claim 1, wherein the intelligent passenger service terminal comprises an intelligent information-service inquiry module, so as to establish a data model and analyze and select big data according to frequently asked questions about passenger travel at subway stations of the rail transit, such that in combination with a more friendly human-machine interface and interactive design, a faster and more customized inquiry experience is provided for a passenger; and
the intelligent information-service inquiry module is integrated with AI interaction, and responds to and answers in real time questions raised by users, 10 popular questions pushed for self-service inquiry and a manual service call button are set on an inquiry interface, when in need of a manual service, a passenger taps an online connection button to enter a video connection interface, and enters a connection interface after connecting, and the interface includes a personal video, a volume status, connection duration information, and a disconnection button.

12. The contactless intelligent customer-service system applied to rail transit according to claim 1, wherein the intelligent passenger service terminal comprises an intelligent navigation guidance module for in-station navigation, station surrounding navigation, and transfer guidance, and the intelligent navigation guidance module is combined with third-party commercial navigation software to perform navigation inside and outside a rail transit subway station based on Bluetooth positioning and navigation technology; and
a map module in the intelligent navigation guidance module displays all route maps of a subway and ground buses in a whole city, and when a passenger enters information of a starting station and of a terminal station to query a route, a route plan and details thereof are highlighted on the route map, so that the passenger can quickly find a travel and transfer route as well as transfer information.

13. The contactless intelligent customer-service system applied to rail transit according to claim 1, wherein the intelligent passenger service terminal is equipped with an intelligent riding guidance module, the intelligent riding guidance module accesses ATS, first- and last-train information, and congestion degree information, such that in addition to a series of information of train operation in real time, a passenger is further provided with information about closure of entrances and exits, a station operation adjustment with a large passenger flow, and an emergency such as a fire, a large-scale train delay, a terrorist attack, and a natural disaster, so as to guide the passenger to travel or avoid an impact of the operational adjustment.

14. The contactless intelligent customer-service system applied to rail transit according to claim 1, wherein the intelligent passenger service terminal is equipped with a manual call service module, when the system cannot meet needs of a passenger or the passenger has urgent needs for help, a real-time video call for inquiry is made to station staff who are responsible for processing inquiries, and the system should be equipped with mobile video intercom equipment for station staff.

15. The contactless intelligent customer-service system applied to rail transit according to claim 1, wherein the intelligent passenger service terminal further comprises the following functional modules:
an advertising interface module configured to display texts, pictures, and videos in rotation, wherein speech wake-up guidance is set up in a central region of the interface, and in this way, a passenger is guided to wake up the system by using a speech involving a keyword, and then the system exits the advertising interface module, that is, enters a face recognition interface; and the system automatically switches back to the advertising interface module without sensing an operation of the passenger within 30 s;
a home page module configured for system time display, station 3D model display, general emergency message display, and comprising a home button, an information service button, a map button, a train information button, and an inquiry button, wherein when the passenger taps the button on the interface, the system module automatically switches to a corresponding module interface;
an information service module configured to display an interface of an information service list and corresponding list content, wherein the information service list is on the left side of the display interface, and when the passenger taps a data bar in the list, corresponding information data content is displayed on the right side;
a train information module configured to display first- and last-train time information of a transfer line, running information of upward and downward trains, information of first two trains of different lines, a name of a next station, terminal station information, arrival time information, and comfort information, according to different platforms, where the text information is displayed in a standard color corresponding to a line name, and information of different lines is displayed in rotation; and
a full-screen emergency message module, configured to enable intelligent passenger service terminal equipment to automatically switch to a full-screen emergency message mode when an emergency occurs at a station.

16. An application method for the contactless intelligent customer-service system applied to rail transit according to claim 1, comprising the following steps:
step 1: unidirectionally accessing each interface system information by using network isolation equipment, aggregating these information, and sending the aggregated information to an intelligent customer-service interface server, wherein each of interface systems includes: a weather forecast interface, a subway line map interface, a bus and subway transfer information interface, an ATS system interface, a clock system interface, a first- and last-train system interface, an emergency message system interface, and a congestion degree system interface;
step 2: obtaining, by the intelligent customer-service interface server, information closely related to a passenger service, and forwarding the information to a passenger service platform server, wherein information closely related to passenger scheduling includes a weather forecast, a subway line map, bus and subway transfer information, ATS system driving information, clock system information, first- and last-train information, emergency message system interface information, and congestion degree information;
step 3: according to a predefined operational business definition and logic, associating, by the intelligent passenger service interface server, comprehensive information of these interfaces, training a model, and performing statistical analysis and decision-making;
step 4: performing, by a linkage engine of the intelligent passenger platform server, inter-system linkage, based on input conditions;
step 5: pushing, by the intelligent passenger platform server, a linkage result and an analysis decision result to the intelligent passenger service terminal; and
step 6: displaying, by the intelligent passenger service terminal, the pushed information, and responding to an interaction instruction of a passenger.

17. The application method according to claim 16, wherein the weather forecast interface provides the system with information such as a current day weather, a dynamic weather forecast in next 1 to 3 hours, and a weather in next 7 days;
the subway line map interface provides the system with a latest urban rail transit subway line map;
the bus and subway transfer information interface provides the system with transfer information between an urban subway and a ground public transportation system, and the transfer information comprises travel time, congestion degrees, walking distances, travel costs, and transfer times of a travel path;
the ATS system interface provides the system with information on whether an operating train is in a normal operating mode, a main operating condition of a signal system, and an operating timetable;
the clock system interface provides the system with reference master clock time information and a reference time;
the first- and last-train system interface provides the system with a timetable of first and last trains of each station of a rail transit subway;
the emergency message system interface provides the system with release of various emergency messages, including fire information, large-scale train delay information, terrorist attack information, and natural disaster information, where the fire information is provided by a FAS subsystem interface of a smart station, the large-scale train delay information is provided by an ATS subsystem interface of the smart station, and the terrorist attack information and natural disaster information are provided by a PIS information release system of the smart station; and
the congestion degree system interface provides the system with the congestion degree and comfort information of last three train cars that are about to arrive at the station.

18. The application method according to claim 16, wherein the inter-system linkage performed by the linkage engine based on the input condition is specifically as follows:
the linkage engine, based on the workflow mechanism, organically links systems supporting businesses of the weather forecast, the subway line map, bus and subway transfer, and ATS driving with a clock system, a first- and last-train system, an emergency message system, and a congestion degree system together, and according to a predefined passenger service mechanism, a serial or parallel response to a passenger's interactive command on the service terminal is performed.
